(19) United States
(12) Patent Application Publication
(10) Pub. No.: US 2007/0078559 A1
(43) Pub. Date: Apr. 5, 2007

(54) Document handling apparatus and method using RFID device

(76) Inventor: Richard Rosen, Trumbull, CT (US)

Correspondence Address: KENYON & KENYON LLP, 1500 K STREET N.W., SUITE 700, WASHINGTON, DC, 20005, US

(21) Appl. No.: 11/242,383

(22) Filed: Oct. 3, 2005

(51) Int. Cl. G06F 7/00

(52) U.S. Cl. 700/220; 700/213

(57) ABSTRACT

An RFID system includes an RFID tag imbedded or printed on a print medium, such as a sheet of paper. The tagged sheet is used as part of a mail piece in a document handling system to direct the operation of the system through a controller. Data from the tagged sheet is read at multiple stages of the handling system to verify the identity, contents, and address of the mail piece.

### BACKGROUND OF THE INVENTION

1. Field of the Invention

The present invention generally relates to systems that rely on radio frequency identification (RFID) to impart information in response to an applied RF signal and, more particularly, to using RFID technology to control document compilation in document handling systems such as mail processing.

2. Brief Description of Related Developments

Radio Frequency Identity or Identification (RFID) is a means of storing and retrieving data through electromagnetic transmission to an RF compatible integrated circuit.

RFID tags are generally classified as active tags and passive tags, as defined by their power source. Active tags include both a radio frequency transceiver and a source of power for transmission. Passive tags can be either battery or non-battery operated, as determined by the intended application. Passive tags reflect the RF signal transmitted to them from a reader or transceiver and add information by modulating the reflected signal.

RFID tags consist of two essential components, an integrated circuit, that includes a transceiver, and an antenna for coupling with an external source of excitation, such as a radio signal. The combination device is sometimes referred to as a transponder. The transponder or tag generally communicates by a wireless signal in a process known as coupling. Coupling is generally via antenna structures that form an integral feature of both tag and an external transceiver.

Read-only transponders store information that can be electronically read. The stored information can be, for example, a unique code. In some systems, a signal can be sent to a RFID tag, which charges the tag and allows the information stored in the tag to be returned, thereby creating a read/write tag.

More recently RFID tags have been manufactured by a printing process, which allows the tags to be made at a more reasonable price and also allows the tags to be imprinted or imbedded in thin substrates, such as paper. An example of such tags is described in U.S. Pat. No. 6,851,617, the disclosure of which is incorporated herein by reference. In the '617 patent there is described a method of producing RFID tags using sheets of paper to form a simple and inexpensive structure for supporting RFID transponders. Similar technology is being developed by Precisia LLC. of Ann Arbor, Mich.

A system for using RFID tags imbedded in print media is described in U.S. Pat. No. 6,846,056. The RFID tags are imbedded on sheets which are fed to a printer as part of a stack. The stack of sheets are printed in accordance with the data read from the tags.

It is a purpose of this invention to adapt printed RFID tags to control document processing machinery, such as mail handling systems. A mail handling system of this type is described in U.S. Pat. No. 4,800,505. Another such system is described in U.S. Pat. No. 5,179,522 in which marks, read from a control document control the operation of the system. Yet another example of a mail handling system is described in U.S. Pat. No. 6,429,946. In these systems an identifier, such as a bar code, is printed on a control document and provides, either directly or with reference to a data base, the information required to direct the steps of compiling a series of documents for insertion, addressing, and applying of postage.

### SUMMARY OF THE INVENTION

The present invention presents a method and system for utilizing RFID technology to prepare documents for mailing. In this system RFID tags are printed or imbedded on document sheets being processed by: mail sorting apparatus. The RFID tag contains data that directs the system components in the assembly of a group of documents for mailing.

In another aspect of this invention, an RFID tag is imbedded in a sheet of paper to generate a control document having the necessary information needed to assemble and mail composite mailing pieces involving multiple items.

In another aspect of this invention, the RFID tag is a simple number identifier, which refers the control system of the document handler to a data base containing detailed control information.

In another aspect of this invention, a document is collated and inserted into an envelope that is printed with an address and then franked for mailing. The collated items and address are matched according to data obtained from an RFID tag imbedded on a lead sheet of the document.

In an embodiment of this invention a document handling system is set up with a sorting station, that may include a folding and insertion operation and a printing station. A source of sheets is provided according to the structure of the mailing and may include a separate source for sheets containing an RFID tag. The system includes a reader that receives data from the tag and directs the data to a controller for controlling the operation of the system.

In another embodiment of the invention, a sheet or sheets of paper are imprinted with RFID tags, that contain data used in the operation of a document handling system. The tagged sheet is fed though a reader to impart the operational data to the system. A group of items of a mailing piece are sorted, folded, and inserted according to the operational data from the tag. The packaged document is then addressed and franked using the operational data from the tag.

In another aspect of this invention, the RFID tag travels with the mail piece and thereby allows monitoring of the mail piece identity at various points in the handling path. Verification of the identity of the mail piece and its address may be obtained after the mail piece is packaged and sealed.

In another embodiment of the invention, the document is collated, folded, inserted and sealed in a stand alone system after which it is sent to a printing station that again reads the RFID tag to instruct the printer with respect to the correct address, while also checking the contents.

### BRIEF DESCRIPTION OF THE DRAWINGS

The foregoing aspects and other features of the present invention are explained in the following description, taken in connection with the accompanying drawings, wherein:

FIG. 1 is a plan view of an RFID imbedded in a sheet according to this invention;

FIG. 2 is a plan view of an envelope containing the sheet of FIG. 1 block diagram of an RFID system incorporating features of the present invention;

FIG. 3 is a block diagram of a mail handling system using the RFID of FIG. 1 according to the present invention; and

FIG. 4 is a block diagram of an alternate embodiment of a non-integrated document handling system according to the present invention.

### DETAILED DESCRIPTION OF THE PREFERRED EMBODIMENTS

A system for document handling using RFID tags imprinted or imbedded in print media, and providing the features of the present invention is illustrated in the figures. Although the present invention will be described with reference to the embodiments shown in the drawings, it should be understood that the present invention may have many alternate forms. In addition, any suitable size, shape or type of elements or materials could be used.

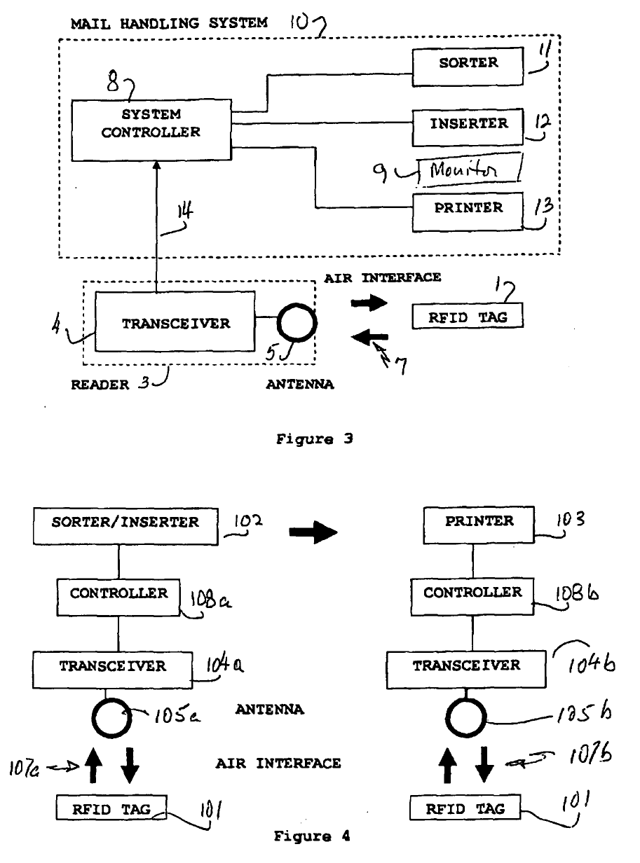

RFID tags 1 are well known and comprise a chip or integrated circuit that includes a transceiver and antenna to send and receive signals according to their particular design requirements. The RFID tag 1 used in the system of this invention is imprinted or imbedded on thin substrates, as described in the '617 patent referenced above. In particular, as adapted in this invention, the substrate is a sheet of paper 2, suitable for printing, to which the RFID tag 1 is applied. A reader 3 is used to communication with the RFID tag 1 as shown in FIG. 3. Reader 3 generally consists of a transceiver 4 and an antenna 5. Once the antenna 5 and the antenna of the RFID tag are coupled through air interface 7, signals from the transceiver 4 excite the RFID tag to transmit data recorded therein which is received by transceiver 4.

RFID tag 1 uses a defined radio frequency and protocol to transmit and receive data from tags. The transceiver 4 can be connected to a controller 8, which might also be connected to a database stored in memory within controller 8. RFID tag 1 may be an active tag or a passive tag, as defined by their power source.

Tag 1 and transceiver 4 generally communicate by a wireless signal in a process known as coupling. Two methods of wireless signal coupling that may be used in RFID systems include close proximity electromagnetic or inductive coupling systems and propagating electromagnetic waves. Coupling is generally via antenna structures that form an integral feature of both tag 8 and transceiver 2.

The sheets of paper 2 having an RFID tag 1 may be set up as individual sheets of a document in which all pages are tagged. More preferrably, the tagged sheet 2 would be used as a lead page having data stored in the tag identifying the mail piece and its contents. Such data may also relate to sorting, collating, folding, and inserting related untagged pages comprising the complete document/mail piece. In this situation the lead page forms part of the document and follows the document through the handling process culminating in the insertion of the document into a package, for example envelope 6. RFID tag 1 and envelope 6 may be designed to enable the tag 1 to be readable after insertion.

A tagged page 2 could also be constructed as a control document having complete project data useable in a conventional document handling system as described in the references cited in the background.

The data stored on RFID tag 1 may be a series of numbers set up in a predetermined sequence or referenced to a data base stored in the memory of a system controller 8, as shown in FIG. 3. The data base may comprise a look up table in which predetermined operating instructions are correlated to the series of numbers.

In all of the document handling processes implemented by the systems according to this invention, the RFID tag travels with the document being processed. This permits the document identification to be checked throughout the handling path and insures that the address to be printed on the document will be accurate. The monitoring of the document may be continuous at all stages of the process and proper handling may be verified.

An integrated mail handling system 10 is shown FIG. 3 and consists of various stations at which the steps of the typical mail handling process are performed. For illustration, the system is shown to include a sorting station 11, an insertion station 12, and a printing station 13. A reader 3 is coupled to RFID tag 2 by means of the cooperating antennas and obtains data stored on the tag. The data is sent to the system controller by means of link 14 and processed for use in operating the mail handling system 10. Link 14 could be a fixed wire connection, a wireless connection or any appropriate means for transmitting the data obtained by reader 3.

A monitor or monitors, such as monitor/reader 9, may be installed at any point in the path of the handling system to read the tag 1, verify the identity of the mail piece, and confirm the address to be printed.

In the alternate embodiment illustrated schematically in FIG. 4, a non-integrated document handling system consists of a separate mail sorter station 102 in which an RFID tag 101a is read at transceiver 104a. Sheets, pages and associated items are then sorted and inserted into a package according to the operational directions contained in the tag 101. The sealed package may be then transported to an independent printing station 103 where it can be addressed and checked. The data contained on RFID tag 101 is read by transceiver 104b at the printer station 103. This requires independent readers at each station. As shown in FIG. 4, at the sorter/inserter station 102, the reader comprises transceiver 104a and antenna 105a which couple with tag 101 over air interface 107a. A second reader is installed at the printer station 103 and comprises transceiver 104b and antenna 105b which couple with tag 101 over air interface 107b. In this manner flexibility of design is introduce at a minimum expense.

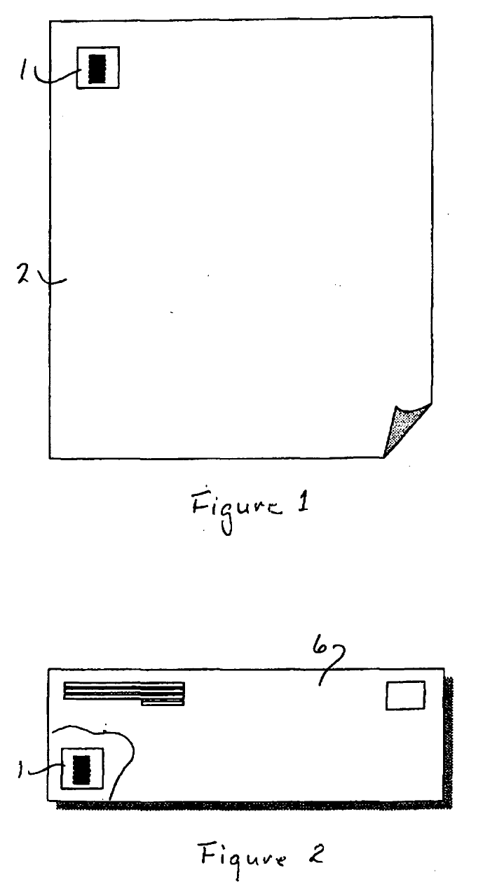

In operation a sheet or sheets of paper 2 are imprinted with RFID tags 1, as shown in FIG. 1. RFID tag 1 may contain data, that identifies a particular mail item, its contents, address, and postage. The tag 1 could also contain preceding and succeeding mail piece identities to maintain mailing sequence without a separate database.

In an alternate embodiment the data may contain only a number from a predetermined sequence correlated to a more detailed data base stored on the system controller 8. The controller data base may be a simple look up table that matches the tag identifier to the contents of a mail piece.

The tagged sheets may be stacked in a separate tray that may be fed though a reader 3 to extract the operational data by coupling to RFID tag 1. The feeding of the tagged pages may alternate with untagged pages and items from other cooperating trays. The reader transmits the extracted data to system controller 8 which for example may identify which pages of a print job belong together in the same envelope. The contents of a mailing is collated, folded, and inserted according to the operational data from the tag. The packaged document is then addressed and franked using the operational data from the tag. This permits the printing of the address on a closed face envelope correctly everytime. As a final step an additional reader contained in a monitor station 9 may check the contents against the tag data and extract information from the data base for printing on the face of the envelope.

As shown in FIG. 4 the printing and franking station may be independent of the document handling system without loosing coordination between the mail piece and its identification.

The contents and address are obtainable at all times as the mail piece is transported through the stations, since the RFID tag 1 travels with the mail piece. This allows a further monitoring of a particular mail piece that was not available in traditional mailing systems, that use optically read markings,i.e. bar code type identifications.

In addition window style envelopes are not needed since an accurate address may be read from the imbedded RFID tag 1 even after the enveloped is stuffed and sealed. The matching of contents to destination is always available by coupling a reader to the tag.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. A system for handling documents comprising:
a lead sheet containing a radio frequency identifier (RFID) tag having data relating to the identity, content and address for the documents accessible thereon;
a reader having a transceiver and antenna for accessing the data on the RFID tag;
a controller connected to the reader for receiving the data from the reader and using said data to direct the operation of the system; and
wherein the lead sheet is part of the document and travels with the document through the handling system.

2. A system, according to claim 1, further comprising:
a monitor having a transceiver and an antenna for accessing the data on the RFID tag to verify the identity and content of the document at a position in the system subsequent to the reader.

3. The system, according to claim 1, further comprising at least a sorting and printing station and wherein the reader precedes the sorting station and the monitor precedes the printing station.

4. The system, according to claim 1, wherein the printing station is further adapted to apply postage to the document.

5. The system, according to claim 3, wherein the document comprises multiple items that are sorted and placed in a package at the sorting station.

6. The system, according to claim 1, wherein at the sorter the lead sheet is taken from a stack of sheets having RFID tags and other untagged items are taken from another source.

7. The system, according to claim 1 wherein the data comprises an identifier correlated to a database in the controller that references operational instructions for identifying and processing the document.

8. The system, according to claim 1 wherein the data on the RFID tag includes an identification of the preceding and succeeding documents.

9. The system, according to claim 3, wherein the sorting and printing stations are not integrated, but are independent and wherein each of the stations includes a reader.

10. The system, according to claim 1, wherein the RFID tag is imprinted on the lead page.

11. The system, according to claim 2, wherein the RFID tag is imbedded in the lead page.

12. In a system for handling documents, a method of controlling the operations thereof comprising the steps of:
constructing a lead page having an RFID tag, the RFID tag containing data relating to the identity, content and address for the documents accessible thereon;
inserting the lead page as part of a document in the document handling system;
reading the RFID tag and directing the data obtained to a controller for use in directing the operation of the document handling system;
transporting the document, including the lead page, through the document handling system with reference to the data contained in the RFID tag.

13. The method, according to claim 12, further comprising the step of monitoring the document by accessing the data on the RFID tag to verify the identity and content of the document at a position in the system subsequent to the step of reading.

14. The method, according to claim 12, wherein the steps of inserting the lead page and reading the RFID tag occur at a sorting station.

15. The method, according to claim 13, wherein the step of monitoring occurs at a printing station.

16. The method, according to claim 12, wherein in the inserting step further includes the step of sorting and placing multiple items in a package at a sorting station.

17. The method, according to claim 16, wherein the lead sheet is inserted by taking the lead sheet from a stack of sheets having RFID tags and wherein other untagged items are taken from another source.

18. The method, according to claim 12, wherein the data on the RFID tag comprises an identifier correlated to a database in the controller that references operational instructions for identifying and processing the document.

19. The method, according to claim 12, wherein the data on the RFID tag includes an identification of the preceding and succeeding documents.

20. The method, according to claim 12, further including the steps of sorting and printing at stations that are not integrated, but are independent and wherein the RFID tag is read at each of the stations.

21. The method, according to claim 12, wherein the RFID tag is imprinted on the lead page.

22. The system, according to claim 12, wherein the RFID tag is imbedded in the lead page.
